(19) United States
(12) Patent Application Publication
(10) Pub. No.: US 2003/0152421 A1
(43) Pub. Date: Aug. 14, 2003

(54) Table corner strengthener

(76) Inventor: Chi-Ching Lu, Tai-Chung Hsien (TW)

Correspondence Address: Lin-Ho LIU, P. O. Box No.6-57, Chung-Ho, Taipei, 235, TW

(21) Appl. No.: 10/073,033

(22) Filed: Feb. 12, 2002

(51) Int. Cl. F16B 7/08; F16L 41/00

(52) U.S. Cl. 403/188

(57) ABSTRACT

The present invention of a table corner strengthener includes a supporting frame, a plurality of side connecting beams and a supporting post; both of the side connecting beam and the supporting post are hollow columnar bodies; the side supporting frame in the supporting frame has an outer periphery to be fitly inserted into the inner periphery of the columnar body of the side connecting beam; the features thereof are that all the side supporting frames are fixedly jointed two by two through the fastening connection between two adjacent and vertical lateral planes of a columnar wedge; the supporting frame is also placed into a cut opening inside the supporting post through the wedge thus to engage with the supporting post; a screw hole inside the supporting post fitly corresponds to a through hole on the lateral plane of each side supporting frame in the supporting frame; therefore, the action force exerted from the supporting frame onto the supporting post can be shared by the cut opening to increase the strength of the assembled structure; the automatic positioning of the wedge and the cut opening as well as the limit control from the surface of the supporting post make the supporting frame and the supporting post vertical to each other so as to achieve the effect of easy assembly and carrying.

### BACKGROUND OF THE INVENTION

1) Field of the Invention

The present invention relates to a table corner strengthener, wherein, a supporting frame is installed into a cut opening of a supporting post through a positioning and load-bearing wedge therein; the side supporting frame in the said supporting frame and a side connecting beam in a hollow body are inserted to joint each other and fastened respectively by a bolt to thereby form a structure easy for assembly and fastening; furthermore, the action force exerted from the supporting frame onto the supporting post can be shared by the cut opening so as to increase the strength of the assembled structure.

2) Description of the Prior Art

A regular supporting frame is usually used for piling or lining up objects in a warehouse, a exhibition hall or at a street vendor; it is mainly demanded to have enough structural strength, be able to facilitate assembly and easy for carrying; however, the structure of a conventional supporting frame, referring to FIG. 1, is mainly comprised by the jointed or inserted incorporating concave slots (A1) and convex posts (B1) respectively disposed on a plurality of columnar supporting posts (A) and side connecting beams (B); wherein, there is no engagement of incorporated wedge or cut opening; therefore, it can't be positioned through the engagement of the said wedge and the said cut opening; neither can it enable the said supporting post fixedly jointed by the said supporting frame through the same engagement to completely rely on a bolt fastened therewith; therefore, the design of the present invention is based on the abovementioned demands.

### SUMMARY OF THE INVENTION

The present invention of a table corner strengthener is designed to achieve the provision of the abovementioned applicative demand; it comprises a supporting frame, a plurality of side connecting beams and a supporting post; both of the said side connecting beam and the said supporting post are hollow columnar bodies; the side supporting frame in the said supporting frame has an outer periphery to be fitly inserted into the inner periphery of the columnar body of the side connecting beam; the features thereof are that all the side supporting frames are fixedly jointed two by two through the fastening connection between two adjacent and vertical lateral planes of the a columnar wedge so as to make all of the said side supporting frame vertical to each other; the supporting frame and the said supporting post are placed into a cut opening inside the supporting post through the wedge inside the said supporting frame; the said wedge fitly fills in the space of the cut opening formed by the cut supporting post and makes a screw hole inside the said supporting post fitly correspond to a through hole on the lateral plane of each side supporting frame of the said supporting frame.

Therefore, the action force exerted from the supporting frame onto the supporting post can be shared by the cut opening so as to increase the strength of the assembled structure; the automatic positioning of the wedge and the cut opening as well as the limit control from the surface of the supporting post make the supporting frame and the supporting post vertical to each other so as to achieve the effect of easy assembly and carrying.

To enable a further understanding of the objectives and the functions of the present invention, the brief description of the drawings below is followed by the detailed description of the preferred embodiment.

### BRIEF DESCRIPTION OF THE DRAWINGS

FIG. 1 is an exploded and pictorial view drawing of a conventional table corner structure.

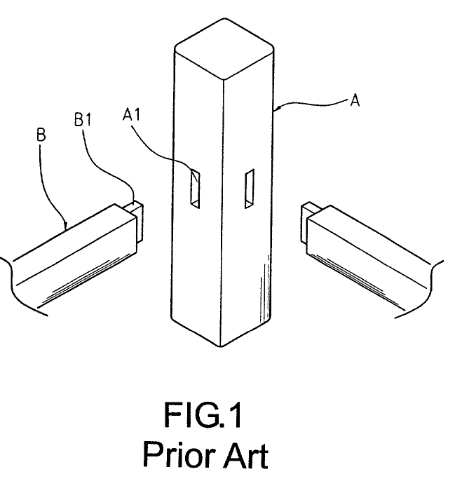

FIG. 2 is an exploded and pictorial view drawing of a table corner strengthening structure of the present invention.

FIG. 3 is an assembled and pictorial view drawing of a table corner strengthening structure of the present invention.

FIG. 4 is a pictorial view drawing of an exemplary embodiment of applying the table corner strengthening structure of the present invention.

### DETAILED DESCRIPTION OF THE PREFERRED EMBODIMENTS

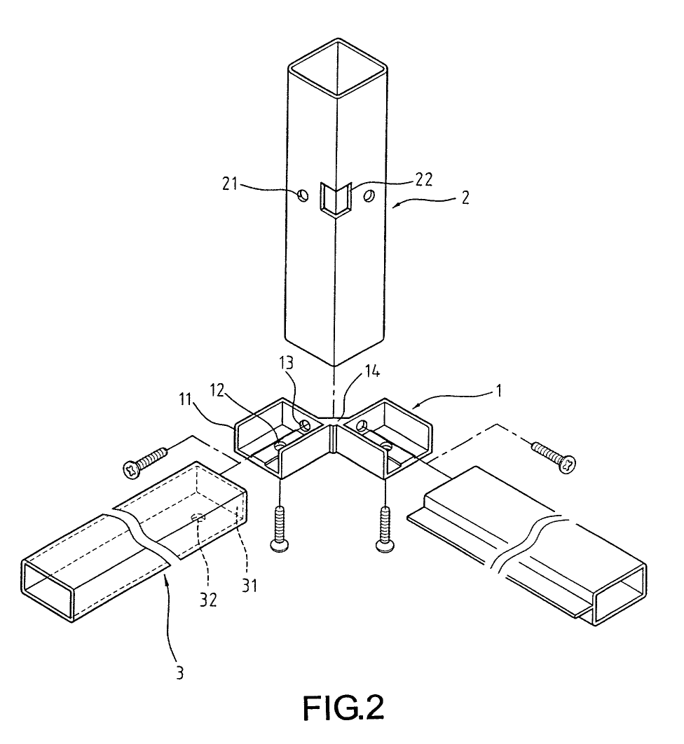

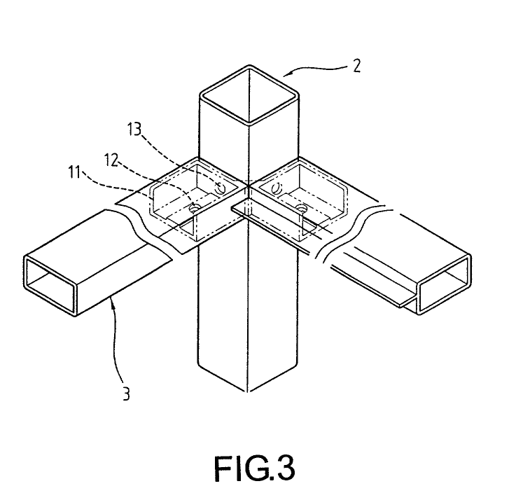

Referring to FIGS. 2 and 3, the preferred exemplary embodiment of the present invention of a table corner strengthener, the present invention mainly comprises a supporting frame (1), a supporting post (2) and a plurality of side connecting beams (3); wherein, the said supporting frame (1) uses two side supporting frames (11) through the fastening connection between two adjacent and vertical lateral planes in a columnar wedge (14) to form a mutually vertical state between the said two side supporting frames (11); each of the said side supporting frame (11) is a hollow rectangular box body; a screw hole (12) and a through hole (13) penetrating the thickness direction are respectively disposed on the bottom plane thereof as well as on the vertical and lateral plane fixedly connecting the said wedge (14); the said screw hole (12) has inner threads; the said supporting post (2) is a hollow columnar body with at least two vertical lateral planes; on two vertical lateral planes inside the said supporting post (2), a screw hole (21) with inner threads is disposed to fit with the through hole (13) of the side supporting frame (11) in the said supporting frame (1); furthermore, at the angle of the said two lateral planes, a cut opening (22) with part of the angle cut off to fit with the wedge (14) of the said side supporting frame (11) is disposed; at least one end of the said side connecting beam (3) is an opening (31) in hollow columnar body with internal dimension fitting with the external dimension of the said side supporting bracket (11); on the lateral plane of the said columnar body, a through hole (32) is disposed to correspond to the screw hole (12) on the bottom plane of the said side supporting frame (11) and to penetrate through the thickness direction of the lateral plane of the said columnar body.

When the said supporting frame (1) and the said supporting post (2) are jointed, the wedge (14) inside the said supporting frame (1) is placed into the cut opening (22) inside the said supporting post (2); the said wedge (14) fitly fills in the space of the cut opening (22) formed by cutting off the said supporting post (2) and makes the screw hole (21) inside the said supporting post (2) fitly correspond to the through hole (13) on the lateral plane of every side supporting frame (11) in the said supporting frame (1); therefore, a proper bolt is used to fasten the said through hole (13) and the said screw hole (21), thereby to stably jointing the said supporting frame (1) and the said supporting post (2) to stay vertically with the said supporting post (2) under the limit control of the surface of the supporting post (2).

When the said side supporting frame (11) and the side connecting beam (3) are jointed, the opening (31)of the said side connecting beam (3) is inserted to the outer periphery of the said side supporting frame (11) and to move along the said side supporting frame (11) to an ultimate position, so that the through hole (32) inside the said side connecting beam (3) fitly correspond to the screw hole (12) on the bottom plane of the side supporting frame (11); a proper bolt is used to fasten the said through hole (32) and the said screw hole (12) to stably joint the said side supporting frame (11) and the said side connecting beam (3); furthermore, two side connecting beams (3) jointed respectively with the said two side supporting frame (11) are vertical to each other under the limit control from the said two side supporting frames (11).

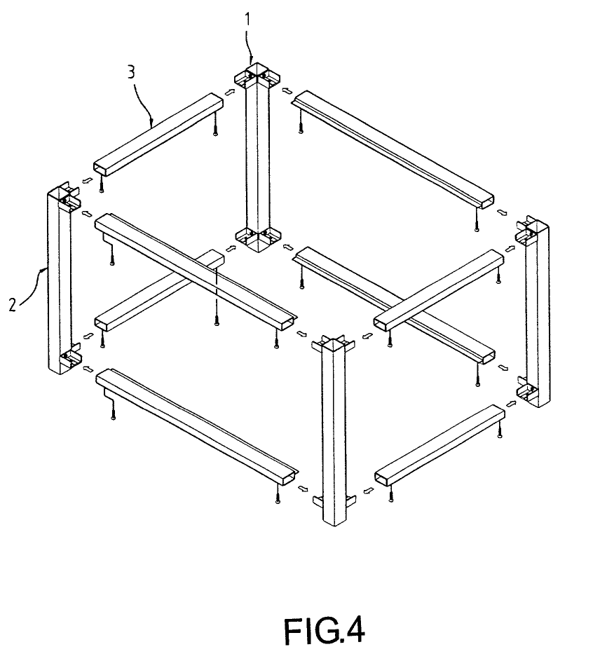

Referring to FIG. 4, through the engagement between a plurality of supporting frames (1) with two vertical side supporting frames (11) and a plurality of side connecting beams (3) and supporting posts (2), a three-dimensional display rack with multiple layers can thereby be composed.

The said supporting frame (1) composed by a plurality of side supporting frames (11) can easily achieve the assembly demand of various beam rack structure by alternating the number of the side supporting frame (11) and the design of the angle of fastening connection.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A table corner strengthener includes a supporting frame, a plurality of side connecting beams and a supporting post; both of the side connecting beam and the supporting post are hollow columnar bodies; the side supporting frame in the supporting frame has an outer periphery to be fitly inserted into the inner periphery of the columnar body of the side connecting beam; the present invention is characterized that:
the said supporting frame uses a plurality of side supporting frames fixedly jointed two by two through the fastening connection between two adjacent and vertical lateral planes of the a columnar wedge to form a mutually vertical state among all the said side supporting frames; each of the said side supporting frame is a hollow rectangular box body; a screw hole and a through hole penetrating the thickness direction are respectively disposed on the bottom plane thereof and the vertical and lateral plane fixedly connecting the said wedge; the said screw hole has inner threads;
the said supporting post is a hollow columnar body with at least two vertical lateral planes; a screw hole with inner threads to fit with the through hole of the side supporting frame in the said supporting frame is disposed on the vertical and lateral planes inside the said supporting post; furthermore, at the angle of the said two lateral planes, a cut opening is disposed with part of the angle cut off to fit with the wedge of the said side supporting frame; at least one end of the said side connecting beam is an opening in hollow columnar body with internal dimension fitting with the external dimension of the said side supporting frame; on the lateral plane of the said columnar body, a through hole is disposed to correspond to the screw hole on the bottom plane of the said side supporting frame and to penetrate through the thickness direction of the lateral plane of the said columnar body.
